(19) United States
(12) Patent Application Publication
(10) Pub. No.: US 2026/0237242 A1
(43) Pub. Date: Aug. 13, 2026

(54) ELECTRONIC DEVICE, CONTROL METHOD, AND NON-TRANSITORY COMPUTER READABLE MEDIUM

(71) Applicant: CANON KABUSHIKI KAISHA, Tokyo (JP)

(72) Inventor: Takahiro USAMI, Tokyo (JP)

(21) Appl. No.: 19/460,539

(22) Filed: Jan. 27, 2026

(30) Foreign Application Priority Data
Feb. 12, 2025 (JP) 2025-020714

(51) Int. Cl. G06V 40/20; G06F 3/01; G06F 3/14; G06F 3/16

(52) U.S. Cl. CPC G06V 40/28; G06F 3/016; G06F 3/14; G06F 3/16; G06V 2201/07

(57) ABSTRACT

An electronic device according to the present disclosure includes a processor, and a memory storing a program which, when executed by the processor, causes the electronic device to execute executing detection processing of detecting selection of an object by an indicator on a basis of a captured image of a real space including the object and the indicator, executing acquisition processing of acquiring information regarding the object, and in a case where the selection of the object by the indicator is detected by the detection processing, executing control processing of performing control so as to give, to a user, a notification based on the information acquired by the acquisition processing.

### BACKGROUND

### Field of the Technology

The present disclosure relates to an electronic device, and more particularly, to a technique for notifying a user of information regarding an object included in a captured image of a real space (an image obtained by capturing a real space).

### Description of Related Art

A technique for notifying a user of information regarding an object included in a captured image of a real space has been proposed.

International Publication No. 2013/168732 discloses a technique for vibrating a housing according to an object included in a captured image. Japanese Patent Laid-Open No. 2010-198433 discloses a technique for selecting one object from a plurality of objects displayed on a display screen.

However, in the technique disclosed in International Publication No. 2013/168732, an arbitrary object cannot be selected in a case where a plurality of objects are included in a captured image. In the technique disclosed in Japanese Patent Laid-Open No. 2010-198433, the user needs to designate the position of the object to be notified on the display screen of the electronic device, and it is difficult to designate a desired position in a case where the display screen of the electronic device is small or in a case where the objects are dense on the display screen.

Furthermore, in the technique disclosed in Japanese Patent Laid-Open No. 2010-198433, the electronic device is an electronic device (such as a smartphone) in which an optical system for imaging is provided on a side opposite to the display screen, and in a case where the imaging range is dazzled, it may be difficult for the user to visually recognize the display screen due to the dazzling. Also in this case, it is difficult to designate a desired position.

### SUMMARY

The present disclosure provides a technique that enables a user to easily select a desired object included in a captured image of a real space.

An electronic device according to the present disclosure includes a processor, and a memory storing a program which, when executed by the processor, causes the electronic device to execute executing detection processing of detecting selection of an object by an indicator on a basis of a captured image of a real space including the object and the indicator, executing acquisition processing of acquiring information regarding the object, and in a case where the selection of the object by the indicator is detected by the detection processing, executing control processing of performing control so as to give, to a user, a notification based on the information acquired by the acquisition processing.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram of an imaging device and a vibration device according to a first embodiment.

FIG. 2 is a schematic diagram of a use scene of the imaging device and the vibration device according to the first embodiment.

FIG. 3 is a schematic diagram of a recognition image according to the first embodiment.

FIG. 4 is a schematic diagram of a display image according to the first embodiment.

FIG. 5 is a schematic diagram of a vibration pattern according to the first embodiment.

FIG. 6 is a list of vibration information based on an object category according to the first embodiment.

FIG. 7 is a list of vibration information based on numerical information according to the first embodiment.

FIG. 8 is a list of vibration information based on character information

according to the first embodiment.

FIG. 9 is a schematic diagram of an operation of the imaging device according to the first embodiment.

FIG. 10 is a flowchart illustrating an operation of the imaging device according to the first embodiment.

FIGS. 11A and 11B are schematic diagrams of object selection according to the first embodiment.

### DESCRIPTION OF THE EMBODIMENTS

Hereinafter, embodiments of the present disclosure will be described with reference to the drawings.

### First Embodiment

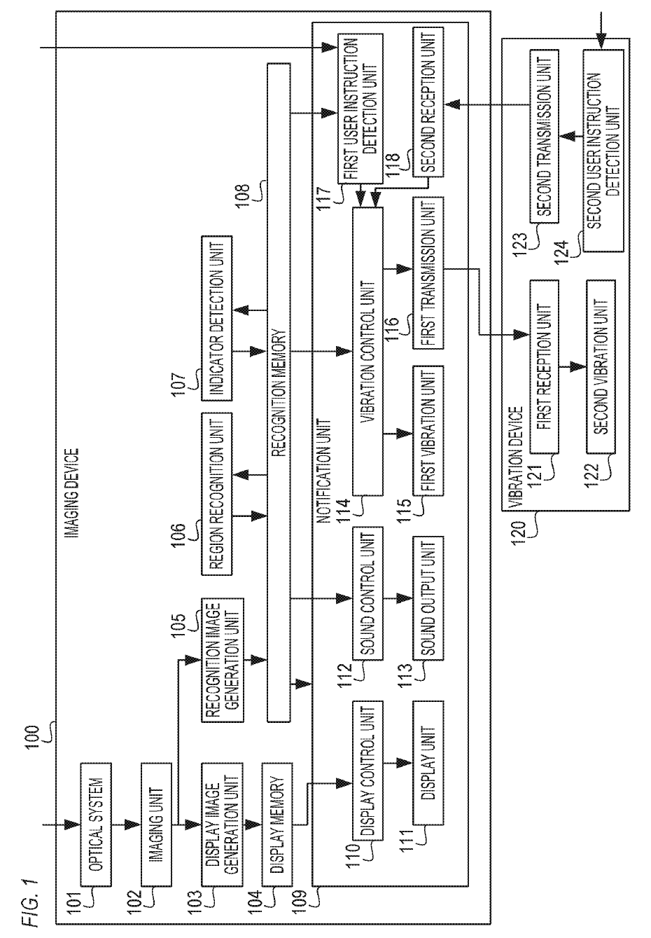

FIG. 1 is a block diagram illustrating a configuration example of an imaging device 100 and a vibration device 120 according to a first embodiment of the present disclosure. The imaging device 100 detects selection of an object by an indicator from a captured image of a real space including the object and an indicator. The object is not particularly limited, and may be a predetermined type of object including at least one of an object including a character, an object including a number, and an object including braille. The indicator is not particularly limited, and may be a finger of the user or an object (an attachment to be worn on a finger, an indicator rod, or the like) at the position of the hand of the user. Then, in a case where the selection of the object by the indicator is detected, the imaging device 100 performs control to notify the user based on the information (object information) regarding the object by display, sound output, vibration, or the like. For example, the imaging device 100 transmits vibration information to the vibration device 120 worn on a finger or the like by the user. When receiving the vibration information transmitted from the imaging device 100, the vibration device 120 vibrates according to the received vibration information.

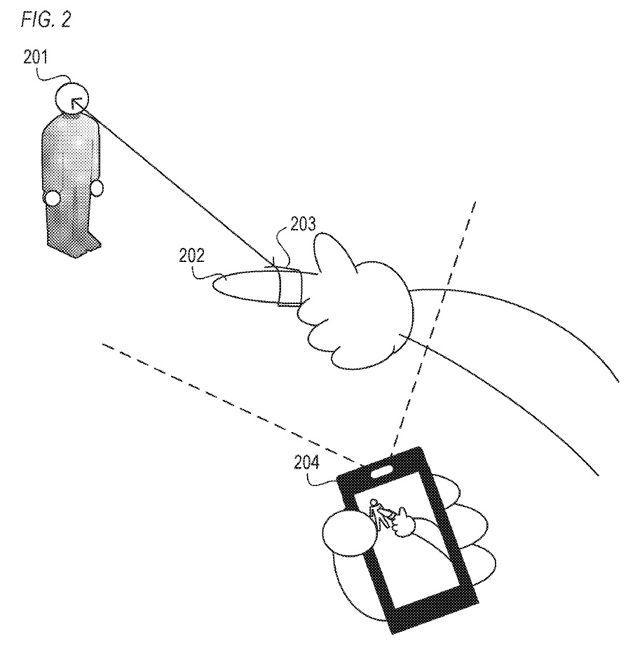

FIG. 2 is a schematic diagram of use scenes of the imaging device 100 and the vibration device 120. In FIG. 2, the imaging device 100 is a smartphone 204 possessed by the user, and the vibration device 120 is a smart ring 203 worn on the finger of the user. When an object 201 and a finger 202 as an indicator are imaged by the smartphone 204 and selection of the object 201 by the finger 202 is detected, the finger 202 and the object 201 are associated with each other. Then, vibration information (or object information) corresponding to the object 201 is transmitted from the smartphone 204 to the smart ring 203. The smart ring 203 notifies the user with the vibration based on the received vibration information (or object information). As a result, the user can be notified when the object 201 is selected with the finger 202.

As illustrated in FIG. 1, the imaging device 100 includes an optical system 101, an imaging unit 102, a display image generation unit 103, a display memory 104, a recognition image generation unit 105, a region recognition unit 106, an indicator detection unit 107, a recognition memory 108, and a notification unit 109. The notification unit 109 includes a display control unit 110, a display unit 111, a sound control unit 112, a sound output unit 113, a vibration control unit 114, a first vibration unit 115, a first transmission unit 116, a first user instruction detection unit 117, and a second reception unit 118. The vibration device 120 includes a first reception unit 121, a second vibration unit 122, a second transmission unit 123, and a second user instruction detection unit 124.

The optical system 101 is a lens unit including a plurality of lenses, and includes, for example, a zoom lens. The imaging unit 102 converts an optical image formed on the imaging sensor via the optical system 101 into electrical information, and outputs the electrical information to the display image generation unit 103 and the recognition image generation unit 105. As the imaging sensor, for example, a complementary metal oxide semiconductor (CMOS) image sensor or the like is used. The CMOS image sensor includes a color filter of a primary color Bayer array.

In the imaging sensor, a plurality of pixels having a photoelectric conversion region are two-dimensionally arranged. The imaging unit 102 converts an optical image into an electric signal group (analog image signal) by a plurality of pixels of the imaging sensor. In imaging, an analog image signal is converted into digital image data by an A/D converter included in the imaging unit 102. Note that the A/D converter may be provided outside the imaging unit 102.

The imaging unit 102 applies color interpolation processing to the image data converted by the A/D converter, and outputs the image data (captured image) to which the color interpolation processing has been applied to the display image generation unit 103 and the recognition image generation unit 105. The color interpolation processing is also called demosaic processing, and is processing of adjusting pixel data such that each of a plurality of pieces of pixel data constituting image data has values of an R component, a G component, and a B component. Furthermore, the imaging unit 102 may perform reduction processing of reducing the number of pixels on the image data converted by the A/D converter according to processing capability or the like.

The display image generation unit 103 performs white balance correction processing, shading correction processing, color space conversion processing from RGB to YUV, resizing processing for display on the display unit 111, and the like on the captured image output from the imaging unit 102 to generate a display image. The display image has a size suitable for display on the display unit 111 (a size corresponding to the size of the display surface). The display image generation unit 103 stores the display image (image data) in the display memory 104.

The recognition image generation unit 105 performs, on the captured image, predetermined image processing for enhancing detection accuracy (for example, accuracy of processing of detecting an object and an indicator) of selection of an object by an indicator, acquisition accuracy of object information, and the like, and generates a recognition image. The predetermined image processing includes, for example, at least one of white balance correction processing, shading correction processing, color space conversion processing, and reduction processing. The color space conversion processing may be a process of converting the color space from RGB to YUV, and the reduction processing may be a process of reducing the size of the image (image size) to a size optimal for recognition by the region recognition unit 106. The size of the recognition image can vary depending on processing performance and processing time of the region recognition unit 106. For example, in a case where 60 images are processed per second, the region recognition unit 106 needs to complete recognition for one image in less than 1/60 seconds a processing time. For example, it is assumed that the maximum image size at which the region recognition unit 106 can complete recognition for one image in less than 1/60 seconds is an image size of 640 pixels in the horizontal direction and 480 lines in the vertical direction. In this case, the recognition image generation unit 105 performs reduction processing so that the size of the captured image is 640 pixels or less in the horizontal direction and less than the image size of 480 lines in the vertical direction. The recognition image generation unit 105 stores the recognition image (image data) in the recognition memory 108.

The region recognition unit 106 reads the recognition image from the recognition memory 108, detects and recognizes an object from the read recognition image, and acquires object information. Then, the region recognition unit 106 stores region information indicating the object region (region of the object) and the object information in the recognition memory 108. As described above, the object to be detected and recognized may be an object of a predetermined type (predetermined category) including at least one of an object including characters, an object including numbers, and an object including braille. For example, the region recognition unit 106 acquires, as the object information, information such as the object type (object category), characters included in the object, numbers included in the object, and braille included in the object.

Examples of the object category include (1) persons, dogs, cats, and other animals, (2) cars, motorcycles, bicycles, and other vehicles, (3) traffic lights, signs, buttons, switches, high-temperature objects, and other caution objects, (4) specific persons, and (5) specific objects. For example, in a case where the degree of coincidence between the region of the object detected from the recognition image and the person image prepared by the user is higher than a threshold, the region recognition unit 106 recognizes that the object is a specific person. The region recognition unit 106 can recognize an object using a known technique. For example, the region recognition unit 106 may recognize an object using a learned neural network.

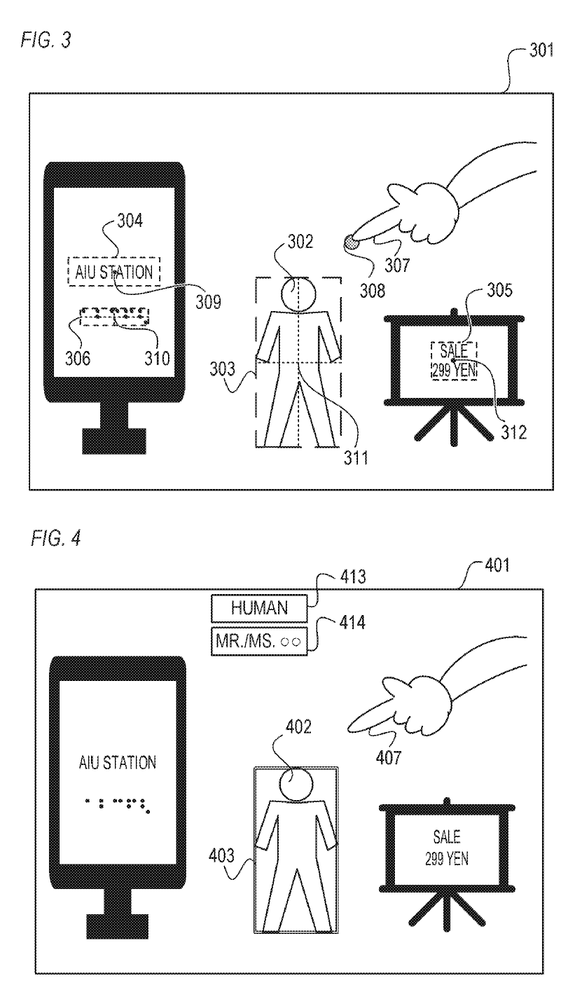

FIG. 3 is a schematic diagram illustrating an example of the recognition image. In FIG. 3, a recognition image 301 includes a person 302. The region recognition unit 106 detects and recognizes an object region 303 that is a region of the person 302, and stores the region information indicating the object region 303 in the recognition memory 108. The region information indicating the object region indicates, for example, coordinates of an upper left corner of the object region, a width of the object region, and a height of the object region. The coordinates (horizontal position, vertical position) of the upper left corner of the recognition image 301 are, for example, (0,0). The region information indicating the object region may be information indicating coordinates of an upper left corner and coordinates of a lower right corner of the object region. Further, the region recognition unit 106 stores information indicating that the object category is “person” in the recognition memory 108 as the object information of the object region 303.

In a case where the recognition image 301 includes characters, numbers, and braille, the region recognition unit 106 detects and recognizes an object region including at least one of characters, numbers, and braille, and stores region information indicating the object region and the object information in the recognition memory 108. For example, the region recognition unit 106 detects and recognizes an object region 304 including characters, an object region 305 including both characters and numbers, and an object region 306 including braille, and stores these pieces of region information in the recognition memory 108. Then, the region recognition unit 106 stores, as the object information of the object region 304, information indicating that the object category is “character” and the character information is “Aiu station” in the recognition memory 108. The region recognition unit 106 stores, as the object information of the object region 305, information indicating that the object category is “character and number” and the character/numerical information is “SALE 299 Yen” in the recognition memory 108. The region recognition unit 106 stores, as the object information of the object region 306, information indicating that the object category is “braille” and the character information corresponding to the braille is “Aiu station (kana)” in the recognition memory 108.

The indicator detection unit 107 reads a recognition image from the recognition memory 108, detects an indicator from the recognition image, and detects selection of an object by the indicator. As described above, the indicator is a finger of the user, an attachment to be worn on the finger, an indicator rod, or the like.

In a case where the indicator is detected, the indicator detection unit 107 estimates the position indicated by the indicator in the recognition image, and stores coordinates of the estimated position in the recognition memory 108. The indicator detection unit 107 reads region information of one or more object regions from the recognition memory 108. The indicator detection unit 107 acquires (calculates) coordinates (for example, coordinates of the center of the object region) of the object region from the read region information. The indicator detection unit 107 detects the selection of the object by the indicator on the basis of the relationship between the coordinates of the position indicated by the indicator and the coordinates of one or more object regions, and associates the indicator with the selected object (object region). The indicator detection unit 107 stores information indicating association between the indicator and the object region in the recognition memory 108. In a case where the indicator is not included in the recognition image (captured image), the selection of the object by the indicator is not detected, and the indicator detection unit 107 stores information indicating that there is no association in the recognition memory 108. Even in a case where the indicator is included in the recognition image (captured image) but the selection of the object by the indicator is not detected, the indicator detection unit 107 stores information indicating that there is no association in the recognition memory 108.

The indicator detection unit 107 can detect an indicator or estimate a position indicated by the indicator using a known technique. For example, the indicator detection unit 107 may detect the indicator or estimate the position indicated by the indicator using a learned neural network.

Here, an example of processing of detecting selection of an object by an indicator will be described. First, the indicator detection unit 107 detects an object region having the shortest distance between the coordinates of the object region and the coordinates of the position indicated by the indicator. Next, in a case where the distance of the detected object is equal to or less than a predetermined distance (threshold), the indicator detection unit 107 determines that the detected object is selected by the indicator. In a case where the distance is longer than a threshold, the indicator detection unit 107 determines that there is no object selected by the indicator.

An example of processing of the indicator detection unit 107 will be described with reference to FIG. 3. The indicator detection unit 107 detects the user's finger 307, which is an indicator, from the recognition image 301 and estimates a position 308 indicated by the finger 307. The indicator detection unit 107 calculates a center position 309 of the object region 304, a center position 310 of the object region 306, a center position 311 of the object region 303, and a center position 312 of the object region 305. The indicator detection unit 107 calculates the distance from the position 308 to each of the center position 309, the center position 310, the center position 311, and the center position 312 in the recognition image 301. The indicator detection unit 107 determines whether the shortest distance among the calculated four distances is equal to or less than a threshold. In FIG. 3, it is assumed that the distance from the position 308 to the center position 311 of the object region 303 is the shortest, and the distance is equal to or less than the threshold. Therefore, the indicator detection unit 107 associates the finger 307 with the object region 303, and stores information indicating that the object region 303 is associated with the finger 307 in the recognition memory 108.

The notification unit 109 reads the association information from the recognition memory 108, grasps the object region associated with the indicator, and reads the object information of the object region associated with the indicator from the recognition memory 108. Then, the notification unit 109 controls to notify the user based on the read object information. In a case where the indicator detection unit 107 has not detected the indicator, or in a case where the indicator is not associated with the object region even if the indicator is detected, the notification unit 109 performs control so as to issue, to the user, a predetermined notification indicating that no object is selected by the indicator. Note that, in a case where the indicator detection unit 107 has not detected the indicator from the recognition image 301 or in a case where the indicator is not associated with the object region even if the indicator is detected, the notification may not be performed.

The display control unit 110 reads the display image from the display memory 104 and transmits the display image to the display unit 111. As a result, the display image is displayed on the display unit 111. The display unit 111 may be, for example, a liquid crystal display or an organic EL display. In a case where there is an object region associated with the indicator, the display control unit 110, the sound control unit 112, and the vibration control unit 114 perform control to notify the user based on the object information of the associated object region. This notification may depend on the location indicated by the indicator and the location of the object region associated with the indicator.

The display control unit 110 may read the region information of the object region associated with the indicator from the recognition memory 108, and generate a rectangle indicating the object region associated with the indicator on the basis of the region information. Then, the display control unit 110 may perform control so that a rectangle indicating the object region is superimposed on the display image and displayed on the display unit 111.

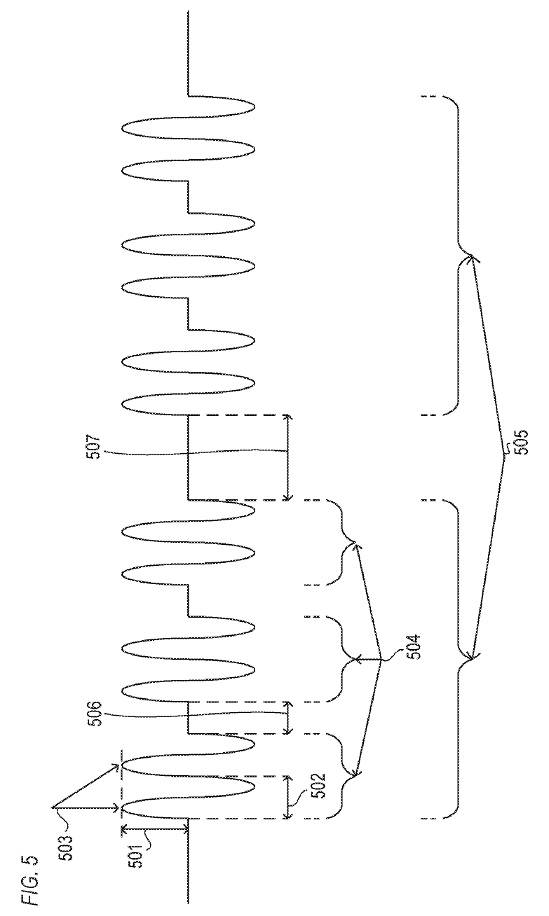

FIG. 4 is a schematic diagram illustrating an example of a display image on which a rectangle indicating an object region associated with an indicator is superimposed. In a display image 401, it is assumed that an object region associated with an indicator 407 is an object region 403 including a person 402. The display control unit 110 generates a rectangle indicating the object region 403 and superimposes the rectangle on the display image 401. The color, type, thickness, and the like of the lines constituting the rectangle may be changed on the basis of the object information of the object region 403. For example, in a case where the object category of the object region 403 is “person”, the color of the line may be green. In a case where the object category of the object region 403 is “character”, the color of the line may be blue. In this way, by changing the color, type, thickness, and the like of the lines constituting the rectangle indicating the object region according to the object category, the user can easily visually understand the object category of the object region associated with the indicator 407.

The rectangle may blink (flashing) or the speed thereof may be changed according to the object category. For example, it is assumed that the object category of the object region associated with the indicator 407 is a caution object such as “high-temperature object”. In this case, the display control unit 110 may repeat superimposition and non-superimposition of the rectangle so that the rectangle indicating the object region blinks. As described above, by blinking the rectangle in a case where the object associated with the indicator 407 is a caution object, it is easy for the user to visually understand that attention is required.

Furthermore, the color, type, thickness, and the like of the lines constituting the rectangle indicating the object region may be changed according to the distance (two-dimensional distance) between the center position of the object region 403 and the position indicated by the indicator 407 in the captured image and the like. For example, as the type of line, a single frame line may be employed when the distance is equal to or greater than a first threshold, a double frame line may be employed when the distance is less than the first threshold and equal to or greater than a second threshold, and a triple frame line may be employed when the distance is less than the second threshold. In this way, by changing the color, type, thickness, and the like of the lines constituting the rectangle indicating the object region according to the two-dimensional distance, the user can easily visually understand the distance between the position indicated by the indicator 407 and the center position of the object region 403.

Each of the position indicated by the indicator 407 and the region information of the object region 403 may include depth information. In such a case, the color, type, thickness, and the like of the lines constituting the rectangle may be changed according to the three-dimensional distance between the position indicated by the indicator 407 and the center position of the object region 403. For example, as the thickness of the line, one-pixel width may be adopted when the thickness is equal to or larger than the first threshold, two-pixel width may be adopted when the thickness is less than the first threshold and equal to or larger than the second threshold, and four-pixel width may be adopted when the thickness is less than the second threshold. In this way, by changing the color, line type, thickness, and the like of the lines constituting the rectangle indicating the object region according to the three-dimensional distance, the user can easily visually understand the distance between the position indicated by the indicator 407 and the center position of the object region 403 in the real space. The rectangle may blink (flash) or the speed thereof may be changed according to the two-dimensional distance or the three-dimensional distance.

Furthermore, the display control unit 110 may perform control to display the object information (object category) of the object region 403 to be superimposed on the display image 401. In FIG. 4, a text 413 “human” indicating the object category “person” of the object region 403 is superimposed by the display control unit 110. In this way, the object information of the object selected by the indicator can be notified to the user by display.

It is assumed that the person 402 is a specific person, and the object category of the object region 403 includes the name of the person 402 “Mr./Ms. ○○”. In this case, as illustrated in FIG. 4, the display control unit 110 may superimpose a text 414 “Mr./Ms. ○○” on the display image 401. Not only the name but also a text indicating that a specific object is selected (such as “match a specific object”) may be superimposed.

The sound control unit 112 reads the object information of the object region associated with the indicator from the recognition memory 108, and generates digital sound information based on the object information. The sound control unit 112 transmits the generated digital sound information to the sound output unit 113.

The sound output unit 113 includes a small speaker and a digital-to-analog converter that can be mounted on a built-in device or the like. The sound output unit 113 converts the digital sound information transmitted from the sound control unit 112 into analog sound information by a digital-to-analog converter, and outputs the analog sound information to a speaker. The speaker notifies the user by outputting a sound corresponding to the analog sound information.

Here, a case where the object information includes color information indicating the main color arrangement of the object region is considered. The main color arrangement of the object region can be detected from a color histogram distribution or the like of the object region. For example, in a case where the main color arrangement of the object region associated with the indicator is “red”, the sound control unit 112 generates digital sound information of “red” from the color information “red” and transmits the digital sound information of “red” to the sound output unit 113. The sound output unit 113 converts the digital sound information of “red (kana)” into analog sound information, and outputs the sound corresponding to the analog sound information from the speaker. As a result, the user can grasp that the main color arrangement of the object region associated with the indicator is “red” from the output sound of the sound output unit 113.

The sound control unit 112 may convert the character information into the digital sound information in a case where the object region associated with the indicator includes characters and the object information of the object region includes character information. For example, in a case where the object region associated with the indicator includes character information of a station name “Aiu station”, the sound control unit 112 may generate digital sound information of “Aiu station (kana)” from the character information “Aiu station”.

In a case where the object information of the object region associated with the indicator includes character information, the sound control unit 112 may generate digital sound information indicating that the object region includes characters. For example, the sound control unit 112 may generate digital sound information of “character information is included (kana)” indicating a sentence “character information is included”. In a case where the object information of the object region associated with the indicator does not include character information, the sound control unit 112 may generate digital sound information indicating that the object region does not include characters. For example, the sound control unit 112 may generate digital sound information of “character information is not included (kana)” indicating a sentence “character information is not included”.

The vibration control unit 114 reads the object information of the object region associated with the indicator from the recognition memory 108, and generates vibration information (vibration pattern) based on the object information. The vibration control unit 114 transmits the generated vibration information to the first vibration unit 115 or the first transmission unit 116. The first vibration unit 115 includes a small vibration motor that can be mounted on a built-in device or the like. The first vibration unit 115 notifies the user by vibrating on the basis of the vibration information transmitted from the vibration control unit 114.

For example, the vibration control unit 114 generates vibration information on the basis of object information of an object region associated with an indicator. The vibration information indicates at least one of an amplitude, a cycle, the number of vibration periods, the length of a vibration period, and an interval between a plurality of vibration periods. The vibration control unit controls at least one of an amplitude 501 (strength) of vibration, a cycle 502, the number of vibration periods, the length of a vibration period, and an interval between a plurality of vibration periods. FIG. 5 is a schematic diagram illustrating an example of a vibration pattern. The amplitude 501 is the amplitude of the vibration, and is also the intensity of the vibration. The cycle 502 is a cycle of vibration. A first vibration count 503 is the vibration count for one cycle and corresponds to the length of the vibration period. In FIG. 5, the first vibration count 503 is 2. A first rest period 506 is a non-vibration period corresponding to an interval between a plurality of vibration periods each corresponding to the first vibration count 503. A second vibration count 504 is the number of repetitions of the vibration group that is the vibration of the first vibration count 503. In a case where the vibration group that is the vibration of the first vibration count 503 is repeated a plurality of times, the vibration group is repeated a plurality of times at intervals of the first rest period 506. It may be interpreted that the second vibration count 504 corresponds to the length of the vibration period. A second rest period 507 is a non-vibration period corresponding to an interval between a plurality of vibration periods each corresponding to the second vibration count 504. A third vibration count 505 is the number of repetitions of the vibration group that is the vibration of the second vibration count 504. It may be interpreted that the third vibration count 505 corresponds to the length of the vibration period. In FIG. 5, when the vibration of the third vibration count 505 is completed, the vibration ends.

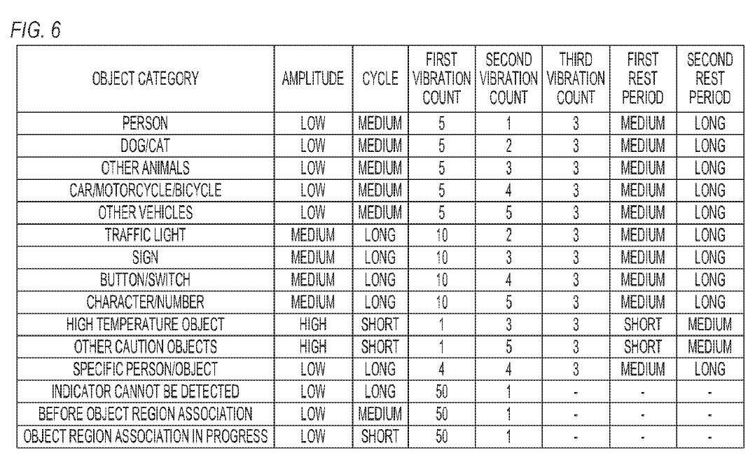

FIG. 6 is a list illustrating an example of vibration information generated on the basis of the object category by the vibration control unit 114. In a case where the object category is “person”, the amplitude 501 is “low”, the cycle 502 is “medium”, the first vibration count 503 is “5”, the second vibration count 504 is “1”, the third vibration count 505 is “3”, the first rest period 506 is “medium”, and the second rest period 507 is “long”. For the amplitude 501, “low” is 5 μm, “medium” is 10 μm, and “high” is 20 μm. In the cycle 502, “short” is 600 Hz, “medium” is 300 Hz, and “long” is 150 Hz. In the first rest period 506 and the second rest period 507, “short” is 300 Hz, “middle” is 150 Hz, and “long” is 75 Hz. In a case where the object category is “dog/cat”, the second vibration count 504 is “2”, and information other than the second vibration count 504 is the same as that in a case where the object category is “person”. In a case where the object category is “another animal”, the second vibration count 504 is set to “3”, and information other than the second vibration count 504 is the same as that in a case where the object category is “person”. In a case where the object category is “car/motorcycle/bicycle”, the second vibration count 504 is set to “4”, and information other than the second vibration count 504 is the same as that in a case where the object category is “person”. In a case where the object category is “another vehicle”, the second vibration count 504 is set to “5”, and information other than the second vibration count 504 is the same as that in a case where the object category is “person”. In a case where the object category is “traffic light”, vibration information is generated so that more detailed information such as color information of the traffic light can be provided to the user. For example, the amplitude 501 is “medium”, the cycle 502 is “long”, the first vibration count 503 is “10”, the second vibration count 504 is “2”, the third vibration count 505 is “3”, the first rest period 506 is “medium”, and the second rest period 507 is “long”. Since the amplitude 501, the cycle 502, and the first vibration count 503 are different from those in the other cases described above, it is possible to notify the user of more detailed information of the object region. In a case where the object category is “sign”, the second vibration count 504 is set to “3”, and information other than the second vibration count 504 is the same as that in a case where the object category is “traffic light”. In a case where the object category is “button/switch”, the second vibration count 504 is set to “4”, and information other than the second vibration count 504 is the same as that in a case where the object category is “traffic light”. In a case where the object category is “characters/numbers”, the second vibration count 504 is set to “5”, and information other than the second vibration count 504 has the same value as that in a case where the object category is “traffic light”. In a case where the object category is a “high-temperature object”, vibration information is generated so that the user can be notified of a danger. For example, the amplitude 501 is “high”, the cycle 502 is “short”, the first vibration count 503 is “1”, the second vibration count 504 is “3”, the third vibration count 505 is “3”, the first rest period 506 is “short”, and the second rest period 507 is “medium”. Since the amplitude 501 and the cycle 502, the first vibration count 503, the first rest period 506, and the second rest period 507 are different from those in the other cases described above, it is possible to notify the user of the danger of the object. In a case where the object category is “another caution object”, the second vibration count 504 is set to “5”, and information other than the second vibration count 504 is the same as that in a case where the object category is “high-temperature object”. In a case where the object category is “specific person/object”, the amplitude 501 is “low”, the cycle 502 is “long”, the first vibration count 503 is “4”, the second vibration count 504 is “4”, the third vibration count 505 is “3”, the first rest period 506 is “medium”, and the second rest period 507 is “long”. Since the combination of the amplitude 501 and the cycle 502 is different from the above-described other cases, it is possible to notify the user that the object is a specific person/object.

In a case where the indicator is not detected by the indicator detection unit 107 (in a case where the indicator is not present in the display image 401), the amplitude 501 is set to “low”, the cycle 502 is set to “long”, the first vibration count 503 is set to “50”, and the second vibration count 504 is set to “1”. The third vibration count 505, the first rest period 506, and the second rest period 507 are not set. Since the vibration information is different from the above-described other cases, it is possible to notify the user that the indicator is not detected (the indicator is not present in the display image 401). In a case where the indicator is detected by the indicator detection unit 107 but the indicator is not associated with the object region, the amplitude 501 is set to “low”, the cycle 502 is set to “medium”, the first vibration count 503 is set to “50”, and the second vibration count 504 is set to “1”. The third vibration count 505, the first rest period 506, and the second rest period 507 are not set. Since the vibration information is different from the other cases described above, it is possible to notify the user that the indicator and the object region are not associated with each other.

Note that the object category and the vibration information described above are examples, and the object category and the vibration information may be appropriately changed and arbitrarily determined. Furthermore, the vibration control unit 114 may switch the vibration control mode on the basis of a user instruction detected by a first user instruction detection unit 117 described later. For example, in the first mode, the vibration control unit 114 performs control to notify the user whether the indicator is associated with the object region. In the second mode, the vibration control unit 114 performs control to notify the user of the object category of the object region associated with the indicator. In the third mode, the vibration control unit 114 performs control to notify the user of any of color information, character information, numerical information, and braille information of the object region associated with the indicator.

The vibration information in the second mode is as described with reference to FIG. 6. In the first mode, for example, in a case where the indicator is not associated with the object region, the amplitude 501 is set to “low”, the cycle 502 is set to “medium”, the first vibration count 503 is set to “50”, and the second vibration count 504 is set to “1” as described above. In a case where the indicator is associated with the object region, the amplitude 501 is set to “low”, the cycle 502 is set to “short”, the first vibration count 503 is set to “50”, and the second vibration count 504 is set to “1”. The third vibration count 505, the first rest period 506, and the second rest period 507 are not set. By changing the vibration information depending on whether the indicator is associated with the object region, it is possible to notify the user whether the indicator is associated with the object region.

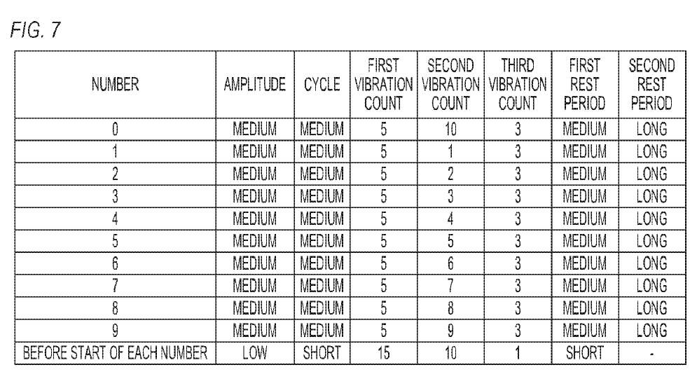

FIG. 7 is a list showing an example of vibration information (vibration information in the third mode) generated by the vibration control unit 114 on the basis of numerical information. In a case where the numerical information is “0”, the amplitude 501 is “medium”, the cycle 502 is “medium”, the first vibration count 503 is “5”, the second vibration count 504 is “10”, the third vibration count 505 is “3”, the first rest period 506 is “medium”, and the second rest period 507 is “long”. In a case where the numerical information is “1”, the second vibration count 504 is set to “1”, and the information other than the second vibration count 504 is the same as that in the case where the numerical information is “0”. In a case where the numerical information is “2”, the second vibration count 504 is set to “2”, and the information other than the second vibration count 504 is the same as that in the case where the numerical information is “0”. In a case where the numerical information is “3”, the second vibration count 504 is set to “3”, and the information other than the second vibration count 504 is the same as that in the case where the numerical information is “0”. In a case where the numerical information is “4”, the second vibration count 504 is set to “4”, and the information other than the second vibration count 504 is the same as that in the case where the numerical information is “0”. In a case where the numerical information is “5”, the second vibration count 504 is set to “5”, and the information other than the second vibration count 504 is the same as that in the case where the numerical information is “0”. In a case where the numerical information is “6”, the second vibration count 504 is set to “6”, and the information other than the second vibration count 504 is the same value as that in the case where the numerical information is “0”. In a case where the numerical information is “7”, the second vibration count 504 is set to “7”, and the information other than the second vibration count 504 is the same as that in the case where the numerical information is “0”. In a case where the numerical information is “8”, the second vibration count 504 is set to “8”, and the information other than the second vibration count 504 is the same as that in the case where the numerical information is “0”. In a case where the numerical information is “9”, the second vibration count 504 is set to “9”, and the information other than the second vibration count 504 is the same as that in the case where the numerical information is “0”.

In a case where the numerical information indicates a plurality of numbers, the vibration control unit 114 generates vibration information of each number and generates vibration information indicating before the start of each number. Then, before each numerical value is notified to the user, the vibration control unit 114 sequentially outputs the plurality of pieces of vibration information so that the user is notified that it is before the start of each numerical value. A case where the numerical information represents a four-digit number will be described. In this case, vibration information before the start of the first number, vibration information of the first number, vibration information before the start of the second number, vibration information of the second number, vibration information before the start of the third number, vibration information of the third number, vibration information before the start of the fourth number, and vibration information of the fourth number are generated. Then, these pieces of vibration information are output in the above order. In this way, it is possible to notify the user of a four-digit number. For example, in the vibration information before the start of each number, the vibration control unit 114 sets the amplitude 501 to “low”, the cycle 502 to “short”, the first vibration count 503 to “15”, the second vibration count 504 to “10”, the third vibration count 505 to “1”, and the first rest period 506 to “short”. The second rest period 507 is not set.

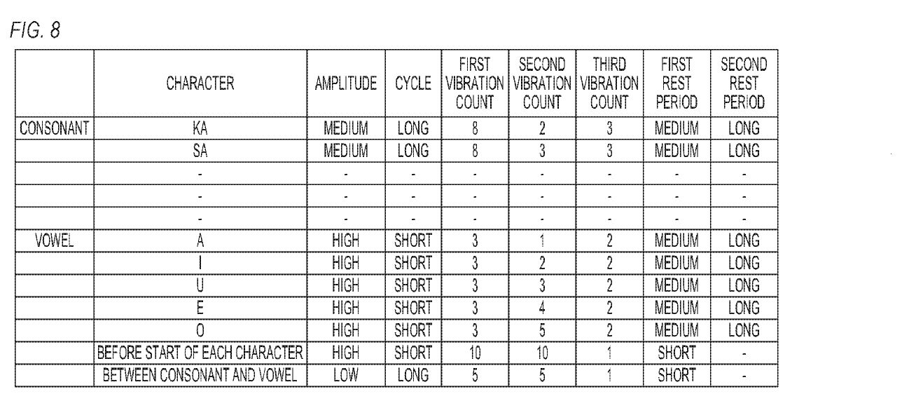

FIG. 8 is a list showing an example of vibration information (vibration information in the third mode) generated by the vibration control unit 114 on the basis of character information. In a case where the character information is “A (kana)”, the amplitude 501 is set to “high”, the cycle 502 is set to “short”, the first vibration count 503 is set to “3”, the second vibration count 504 is set to “1”, the third vibration count 505 is set to “2”, the first rest period 506 is set to “middle”, and the second rest period 507 is set to “long”. In a case where the character information is “I (kana)”, the second vibration count 504 is set to “2”, and information other than the second vibration count 504 is the same as that in the case where the character information is “A (kana)”. In a case where the character information is “U (kana)”, the second vibration count 504 is set to “3”, and information other than the second vibration count 504 is the same as that in a case where the character information is “A (kana)”. In a case where the character information is “E (kana)”, the second vibration count 504 is set to “4”, and information other than the second vibration count 504 is the same as that in the case where the character information is “A (kana)”. In a case where the character information is “O (kana)”, the second vibration count 504 is set to “5”, and information other than the second vibration count 504 is the same as that in a case where the character information is “A (kana)”. In a case where the character information is a character other than “A-row” and represents a character having information about a consonant and a vowel, the vibration control unit 114 generates vibration information about the consonant, vibration information indicating a space between the consonant and the vowel, and vibration information about the vowel, and outputs the vibration information in that order. For example, in the vibration information of the consonant of “Ka-row”, the amplitude 501 is “medium”, the cycle 502 is “long”, the first vibration count 503 is “8”, the second vibration count 504 is “2”, the third vibration count 505 is “3”, the first rest period 506 is “medium”, and the second rest period 507 is “long”. In the vibration information of the consonant of “Sa-row”, the amplitude 501 is “medium”, the cycle 502 is “long”, the first vibration count 503 is “8”, the second vibration count 504 is “3”, the third vibration count 505 is “3”, the first rest period 506 is “medium”, and the second rest period 507 is “long”. In the vibration information indicating the space between the consonant and the vowel, the amplitude 501 is set to “low”, the cycle 502 is set to “short”, the first vibration count 503 is set to “5”, the second vibration count 504 is set to “5”, the third vibration count 505 is set to “1”, and the first rest period 506 is set to “short”. The second rest period 507 is not set. In a case where the character information represents a plurality of characters, the vibration control unit 114 generates vibration information of each character and generates vibration information indicating before the start of each character. Then, before each character is notified to the user, the vibration control unit 114 sequentially outputs the plurality of pieces of vibration information so that the user is notified that it is before the start of each character. In a case where the character information represents two characters, vibration information before the start of the first character, (vibration information of the consonant of the first character, vibration information between the consonant and the vowel of the first character,) and vibration information of the vowel of the first character are generated. Vibration information before the start of the second character, (vibration information of the consonant of the second character, vibration information between the consonant and the vowel of the second character,) and vibration information of the vowel of the second character are generated. Then, these pieces of vibration information are output in the above order. In this way, it is possible to notify the user of the two characters. For example, in the vibration information before the start of each character, the vibration control unit 114 sets the amplitude 501 to “low”, the cycle 502 to “short”, the first vibration count 503 to “10”, the second vibration count 504 to “10”, the third vibration count 505 to “1”, and the first rest period 506 to “short”. The second rest period 507 is not set. The vibration information based on the braille information can be generated by a method similar to that of the vibration information based on the character information. For example, the vibration control unit 114 converts the braille information into character information and generates vibration information from the character information. The vibration information based on the color information can be generated by a method similar to that of the vibration information based on the object category.

The first transmission unit 116 converts the vibration information generated by the vibration control unit 114 into a wireless signal in a format conforming to a communication standard such as Bluetooth (registered trademark), for example, and transmits the wireless signal to the first reception unit 121 of the vibration device 120.

The vibration device 120 transmits and receives a wireless signal to and from the imaging device 100 via the first reception unit 121 and the second transmission unit 123 inside the vibration device 120. The first reception unit 121 extracts the vibration information generated by the vibration control unit 114 from the received wireless signal and transmits the vibration information to the second vibration unit 122. The second vibration unit 122 includes a small vibration motor that can be mounted on a built-in device or the like. The second vibration unit 122 notifies the user by vibrating on the basis of the vibration information transmitted from the first reception unit 121.

In a case where the indicator is included in the recognition image, the first user instruction detection unit 117 reads the recognition image from the recognition memory 108, and recognizes the shape (posture) of the indicator from the read recognition image. The first user instruction detection unit 117 recognizes a specific shape of the indicator as a user instruction, generates a trigger signal for setting a vibration control mode corresponding to the specific shape, and transmits the trigger signal to the vibration control unit 114. In addition, in a case where there is a change from a specific shape to another specific shape as a temporal change in the shape of the indicator, the first user instruction detection unit 117 recognizes the change as a user instruction. Then, the first user instruction detection unit 117 generates a trigger signal for switching the vibration control mode to a mode corresponding to the changed specific shape, and transmits the trigger signal to the vibration control unit 114. The temporal change in the shape of the indicator is detected, for example, on the basis of a plurality of (a plurality of frames of) recognition images in chronological order. The first user instruction detection unit 117 may recognize the shape of the indicator using the learned neural network. The vibration control unit 114 sets and switches the vibration control mode according to the received trigger signal.

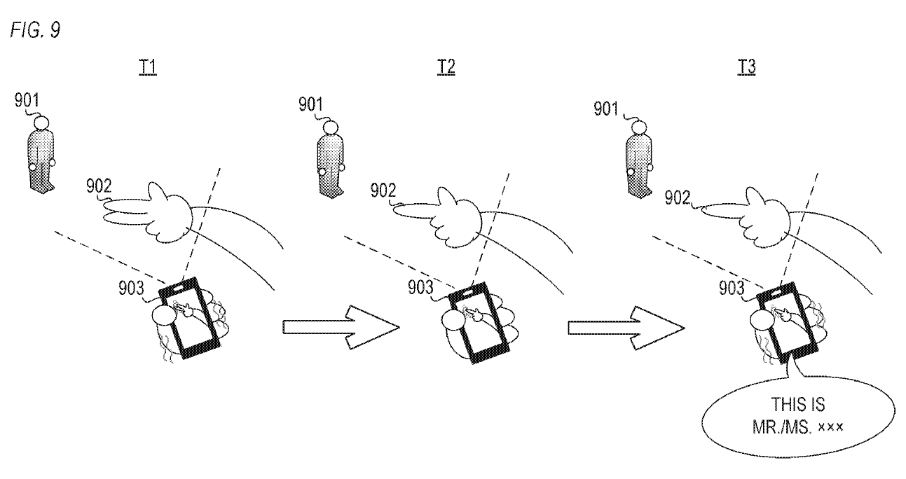

FIG. 9 is a schematic diagram illustrating an example of an operation of the imaging device 100. In FIG. 9, it is assumed that the imaging device 100 is a smartphone 903 possessed by the user.

At time T1, the smartphone 903 captures an image of an object 901 of which the object category is “person” and a hand 902 which is an indicator. The hand 902 takes a posture of selecting an object with two fingers. With this posture, a first mode for notifying the user whether the indicator is associated with the object region is set. Then, since the object 901 is selected with two fingers and the hand 902 is associated with the object region of the object 901, the smartphone 903 notifies the user of the association by vibration of the smartphone 903.

At time T2, the user changes the posture of the hand 902 from the posture of selecting an object with two fingers to the posture of selecting an object with one finger. In response to this posture change, the smartphone 903 switches the vibration control mode from the first mode to the second mode for notifying the user of the object category of the object region associated with the indicator.

At time T3, the smartphone 903 notifies the user that the object category of the object 901 associated with the hand 902 is “person” by the vibration of the smartphone 903. Here, it is assumed that the object 901 is recognized as “Mr./Ms. ×××”. Therefore, the smartphone 903 notifies the user that the object 901 is “Mr./Ms. ×××” by outputting a sound (voice) “This is Mr./Ms. ×××”. As described above, in a case where a plurality of pieces of object information such as “person” and “Mr./Ms. ×××” are acquired as the object information of the object region associated with the indicator, the plurality of pieces of object information may be notified by a plurality of methods (display, sound output, vibration, etc.).

The first user instruction detection unit 117 may include a microphone, a converter that converts analog voice data into digital voice data, and a voice recognizer. The first user instruction detection unit 117 may convert a voice uttered by the user into analog voice data using a microphone and convert the analog voice data into digital voice data using a converter. The first user instruction detection unit 117 may recognize voice content from the converted digital voice data using a voice recognizer, and generate a trigger signal for switching the vibration control mode according to the recognized voice content. For example, in a case where the voice “What is this?” is recognized, the first user instruction detection unit 117 may generate trigger vibration for switching the vibration control mode from the first mode to the second mode. The first user instruction detection unit 117 may recognize a voice (voice content) or detect a specific voice using the learned neural network.

The first user instruction detection unit 117 may detect a gesture of the user from a plurality of frames of recognition images in chronological order, and generate a trigger signal related to vibration control according to the detected gesture. For example, the first user instruction detection unit 117 may detect a gesture in which the indicator draws a circle, and in a case where there is an object region in the vicinity of the center of the circle on the recognition image, generate a trigger signal for notifying the object information of the object region by vibration. In addition, the first user instruction detection unit 117 may detect a ring made by the user's finger and generate a trigger signal for notifying object information of an object region by vibration in a case where the object region is near the center of the ring on the recognition image. As described above, the method of selecting the object (object region) by the indicator is not particularly limited. Note that, although the example of generating the trigger signal related to the vibration control according to the gesture has been described, the trigger signal related to the display control or the sound control may be generated according to the gesture, and the notification may be performed by display or sound output according to the gesture.

In a case where the posture of the hand as the indicator changes from the posture in which one finger is raised to the posture in which three fingers are raised, the first user instruction detection unit 117 may perform control to switch the notification from the notification by the sound output to the notification by vibration. In this manner, the notification method may be switched according to the temporal change in the posture of the indicator. In a case where the posture of the hand as the indicator changes from the posture in which the two fingers are raised and closed to the posture in which the two fingers are opened, the first user instruction detection unit 117 may perform control to start a mode of notifying the object information in association with the indicator and the object region. In a case where the posture of the hand changes from the posture in which the two fingers are opened to the posture in which the two fingers are closed, the first user instruction detection unit 117 may perform control to end the mode. In this manner, the mode may be started or ended according to a temporal change in the posture of the indicator.

The first user instruction detection unit 117 may perform control to change the amplitude of the vibration according to the gesture of changing the distance between the tip of the thumb and the tip of the index finger of the hand that is the indicator in a state where the notification of the object information is performed by the vibration. As a result, for example, when the distance between the tip of the thumb and the tip of the index finger increases, the amplitude of vibration increases, and when the distance between the tip of the thumb and the tip of the index finger decreases, the amplitude of vibration decreases. Even in a state where the notification is performed by sound output, control may be similarly performed to change the volume. As a result, for example, the volume increases as the distance between the tip of the thumb and the tip of the index finger increases, and the volume decreases as the distance between the tip of the thumb and the tip of the index finger decreases. In this manner, the strength of the notification may be changed according to the temporal change in the posture of the indicator.

The second user instruction detection unit 124 of the vibration device 120 can be constructed with a capacitive touch sensor. For example, the second user instruction detection unit 124 can determine whether the user's finger touches the touch sensor portion by detecting a change in the capacitor voltage in the touch sensor. In a case where the user's finger touches the touch sensor portion, the second user instruction detection unit 124 determines that there is a user instruction, and transmits the user instruction detection information to the second transmission unit 123 of the vibration device 120. The second transmission unit 123 converts the user instruction detection information transmitted by the second user instruction detection unit 124 into a wireless signal of a format conforming to a communication standard such as Bluetooth (registered trademark), for example, and transmits the wireless signal to the second reception unit 118 of the imaging device 100.

The second reception unit 118 receives the user instruction detection information generated by the second user instruction detection unit 124, and transmits the user instruction detection information to the vibration control unit 114. The vibration control unit 114 may switch the vibration control (vibration control mode) on the basis of the user instruction detection information generated by the second user instruction detection unit 124. It is assumed that the imaging device 100 is the smartphone 204 possessed by the user, and the vibration device 120 is the smart ring 203 worn on the finger of the user. In this case, when the touch sensor portion of the smart ring 203 worn on the index finger by the user is touched with the thumb, the second user instruction detection unit 124 detects the user instruction and transmits the user instruction detection information to the smartphone 204. Here, in a case where the association between the indicator and the object region is completed, the smartphone 204 switches the vibration control mode in response to the reception of the user instruction detection information and executes the notification of the object category.

The vibration control unit 114 may perform different vibration control on the first vibration unit 115 and the second vibration unit 122. For example, control may be performed such that the first vibration unit 115 notifies by vibration that the association between the indicator and the object region is completed, and the second vibration unit 122 notifies the object category information by vibration. In addition, in a case where “high-temperature object” and “caution object” are acquired as the object information of the object region associated with the indicator, both the first vibration unit 115 and the second vibration unit 122 may be vibrated. In this way, it is possible to strongly notify the user that attention should be paid or that it is dangerous. In the above case where the “high-temperature object” and the “dangerous object” are acquired, all of the display unit 111, the sound output unit 113, the first vibration unit 115, and the second vibration unit 122 may be used. In this way, it is possible to more strongly notify the user that attention should be paid or that it is dangerous. As described above, the plurality of pieces of object information may be notified by a plurality of methods (display, sound output, vibration, etc.) or a plurality of devices. The plurality of pieces of object information may be notified by a plurality of different vibrations, output of a plurality of sounds, a plurality of displays, or the like by the same device.

The vibration control unit 114 may perform control to vibrate the first vibration unit 115 of the imaging device 100 in a case where the indicator is not included in the recognition image, and vibrate the second vibration unit 122 of the vibration device 120 in a case where the indicator is included in the recognition image. By vibrating the first vibration unit 115 and the second vibration unit 122 separately in this manner, it is possible to notify the user which one of the two states is in an easy-to-understand manner. Furthermore, the vibration control unit 114 may perform control to notify a state in which a plurality of indicators are erroneously recognized, a state in which an object cannot be recognized, or the like, as a state of high importance, by vibration of the first vibration unit 115 of the imaging device 100. The vibration control unit 114 may perform control to notify, by vibration of the second vibration unit 122 of the vibration device 120, a state in which a specific object is included in the recognition image, a state in which association between an indicator and an object region is established, or the like, as a state of low importance. The specific object is, for example, an object registered in advance. By vibrating the first vibration unit 115 and the second vibration unit 122 separately in this manner, it is possible to notify the user of whether the importance is high in an easy-to-understand manner.

The region recognition unit 106 may have a depth estimation function of estimating the position of the object in the depth direction (distance from the imaging device 100 to the object in the depth direction) from the recognition image. The region recognition unit 106 stores the estimated position in the depth direction in the recognition memory 108 as object information. The vibration control unit 114 can generate vibration information on the basis of a difference (distance) between the position in the depth direction of the indicator estimated by the indicator detection unit 107 and the position in the depth direction of the object estimated by the region recognition unit 106. For example, when the distance is less than 10 cm, the vibration control unit 114 sets the amplitude 501 to “low”, the cycle 502 to “short”, and the first vibration count 503 to “50”. When the distance is 10 cm or more and less than 50 cm, the amplitude 501 is set to “low”, the cycle 502 is set to “medium”, and the first vibration count 503 is set to “50”. When the distance is 50 cm or more, the amplitude 501 is set to “low”, the cycle 502 is set to “long”, and the first vibration count 503 is set to “50”. In this manner, by making the vibration information different depending on the distance, the user can grasp the distance between the indicator and the associated object by the vibration of the first vibration unit 115.

In a case where the recognition image includes a specific object (pre-registered object), the vibration information may be generated on the basis of the distance between the indicator and the specific object. For example, the vibration information may be generated on the basis of the distance (two-dimensional distance) between the position of the indicator on the recognition image estimated by the indicator detection unit 107 and the position of the specific object on the recognition image.

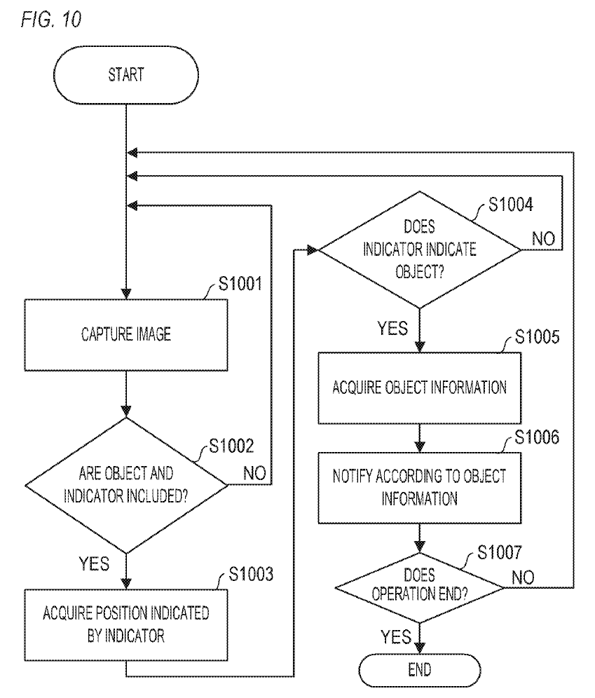

FIG. 10 is a flowchart illustrating an example of the operation of the imaging device 100.

In S1001, the imaging unit 102 images the real space. Furthermore, in S1001, the recognition image generation unit 105 generates a recognition image.

In S1002, the indicator detection unit 107 determines whether the indicator is included in the recognition image. Furthermore, the region recognition unit 106 determines whether an object is included in the recognition image. In a case where the recognition image includes the indicator and the object, the process proceeds to S1003. Otherwise, the process proceeds to S1001.

In S1003, the indicator detection unit 107 acquires the position indicated by the indicator.

In S1004, the indicator detection unit 107 determines whether the indicator indicates an object. In a case where the indicator indicates an object, the process proceeds to S1005, and otherwise the process proceeds to S1001.

In S1005, the region recognition unit 106 acquires object information regarding the object indicated by the indicator.

In S1006, the notification unit 109 controls to notify the user of the object information.

In S1007, the first user instruction detection unit 117 determines whether the user has performed an end operation for ending the operation in FIG. 10. In a case where the end operation has been performed, the operation of FIG. 10 is ended, and otherwise, the process proceeds to S1001.

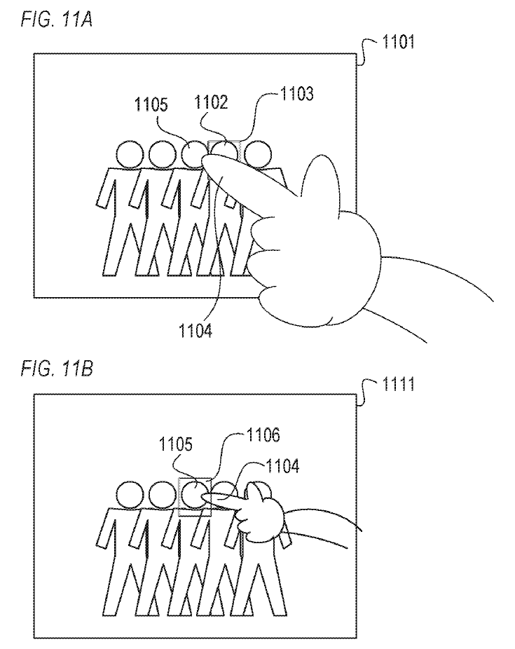

FIGS. 11A and 11B are schematic diagrams illustrating an example of object selection by an indicator in a case where persons are densely present in an image captured by the imaging device 100. Problems caused in the comparative example and effects in the present embodiment will be described with reference to FIGS. 11A and 11B.

A comparative example will be described with reference to FIG. 11A. In the comparative example, the display unit 111 is a touch display, and the user selects an object displayed on the display unit 111 by touching the object with a finger 1104. It is assumed that a display image 1101 displayed on the display unit 111 includes five persons, and the user wants to receive a notification of object information regarding a third person 1105 from the left. In this case, the user tries to touch a region (for example, the region of the head of the person 1105) of the person 1105 in the display image 1101 with the finger 1104. However, in the touch operation, the touch position intended by the user and the touch position recognized on the touch display are shifted from each other. Then, since the display screen of the display unit 111 is small and the display size of the person 1105 is not sufficiently large with respect to the actual size of the finger 1104, there is a high possibility that the touch position is out of the region of the person 1105. In addition, in the display image 1101, since the five persons are dense, there is a high possibility that the touch position is in the region of another person. In FIG. 11A, even though the user tries to select the third person 1105 from the left, a fourth person 1102 from the left is selected. As a result, unintended notification such as display of the frame 1103 indicating the object region of the person 1102 or notification of the object information of the person 1102 is performed to the user.

The present embodiment will be described with reference to FIG. 11B. In the present embodiment, the user points the finger 1104 at the third person 1105 from the left. In this state, a display image 1111 including the finger 1104 is obtained. Since the finger 1104 is brought close to the person 1105, there is little erroneous detection regarding the selection by the finger 1104, and the indicator detection unit 107 can correctly (as intended by the user) detect that the person selected by the finger 1104 is the person 1105. As a result, the notification unit 109 can make a notification (desired notification) intended by the user, such as display of a frame 1106 indicating the object region of the person 1105 or notification of the object information of the person 1105, to the user. As described above, according to the present embodiment, the user can receive a desired notification without receiving an unintended notification.

The imaging device 100 is an electronic device (such as a smartphone) in which an optical system for imaging is provided on a side opposite to the display screen, and in a case where the imaging range is dazzled, it may be difficult for the user to visually recognize the display screen due to the dazzling. In this case, in the comparative example, it is difficult to direct the imaging device 100 to a desired object and to designate a desired position. The user can easily direct the imaging device 100 toward an indicator such as his/her finger. Therefore, in the present embodiment, it is also possible to easily search for a desired object from a glaring place by changing the directions of the indicator and the imaging device 100 while maintaining the state in which the imaging device 100 is directed to the indicator.

### Second Embodiment

In a second embodiment, the imaging device 100 is assumed to be a head mounted display worn on the head of the user. It is assumed that the head mounted display is provided with an optical system and an imaging unit for imaging an angle of view close to the user's field of view. The imaging device 100 detects selection of an object by the indicator on the basis of the captured image obtained by the imaging unit, and performs control to notify the user of the object information of the selected object by vibration or the like. For example, the imaging device 100 vibrates the smart ring by transmitting vibration information to the smart ring worn by the user on the finger. With this vibration, the user is notified of the object information of the selected object.

Note that the object information to be notified may be object information related to the virtual reality world. In this case, the vibration information or the like may be generated on the basis of the object information related to the virtual reality world and the object information of the real world (the object information used in the first embodiment). For example, it is assumed that the coffee cup is given the effect of “physical power recovery” in the virtual reality world. In addition, it is assumed that the effect of “physical power reduction” is given to the beer mug in the virtual reality world. In this case, in a case where the category of the object associated with the indicator is a “coffee cup”, vibration information corresponding to “physical power recovery” may be generated, and in a case where the category of the object is a “beer mug”, vibration information corresponding to “physical power reduction” may be generated. The effect such as “physical power recovery” or “physical power reduction” is, for example, an effect in a game played by the user using the head mounted display.

As described above, according to the present embodiment, selection of an object by an indicator is detected on the basis of a captured image of a real space including the object and the indicator. Then, in a case where selection of an object by the indicator is detected, a notification based on information regarding the object is given to the user. This allows the user to easily select a desired object included in the captured image of the real space.

Note that the above-described various types of control may be processing that is carried out by one piece of hardware (e.g., processor or circuit), or otherwise. Processing may be shared among a plurality of pieces of hardware (e.g., a plurality of processors, a plurality of circuits, or a combination of one or more processors and one or more circuits), thereby carrying out the control of the entire device.

Also, the above processor is a processor in the broad sense, and includes general-purpose processors and dedicated processors. Examples of general-purpose processors include a central processing unit (CPU), a micro processing unit (MPU), a digital signal processor (DSP), and so forth. Examples of dedicated processors include a graphics processing unit (GPU), an application-specific integrated circuit (ASIC), a programmable logic device (PLD), and so forth. Examples of PLDs include a field-programmable gate array (FPGA), a complex programmable logic device (CPLD), and so forth.

The embodiment described above (including variation examples) is merely an example. Any configurations obtained by suitably modifying or changing some configurations of the embodiment within the scope of the subject matter of the present disclosure are also included in the present disclosure. The present disclosure also includes other configurations obtained by suitably combining various features of the embodiment.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-020714, filed February 12, 2025, which is hereby incorporated by reference herein in its entirety.

What is claimed is:

1. An electronic device comprising:
a processor; and
a memory storing a program which, when executed by the processor, causes the electronic device to execute:
executing detection processing of detecting selection of an object by an indicator on a basis of a captured image of a real space including the object and the indicator;
executing acquisition processing of acquiring information regarding the object; and
in a case where the selection of the object by the indicator is detected by the detection processing, executing control processing of performing control so as to give, to a user, a notification based on the information acquired by the acquisition processing.

2. The electronic device according to claim 1, wherein
the captured image includes a plurality of objects, and
in the detection processing, an object selected by the indicator is detected among the plurality of objects.

3. The electronic device according to claim 1, wherein
when the program is executed by the processor, the program further causes the electronic device to execute predetermined image processing on the captured image for enhancing accuracy of the detection processing.

4. The electronic device according to claim 3, wherein
the predetermined image processing includes at least one of white balance correction processing, shading correction processing, color space conversion processing, and reduction processing.

5. The electronic device according to claim 1, wherein
the object is a predetermined type of object.

6. The electronic device according to claim 5, wherein
the predetermined type of object includes at least one of an object including a character, an object including a number, and an object including braille.

7. The electronic device according to claim 1, wherein
the indicator is a finger of the user or an object at a position of a hand of the user.

8. The electronic device according to claim 1, wherein
in the control processing, a control is performed such that the notification is given by display.

9. The electronic device according to claim 1, wherein
in the control processing, a control is performed such that the notification is given by sound output.

10. The electronic device according to claim 1, wherein
in the control processing, a control is performed such that the notification is given by vibration.

11. The electronic device according to claim 10, wherein
the vibration is vibration of a vibration device worn by the user.

12. The electronic device according to claim 10, wherein
in the control processing, the vibration is controlled on a basis of the information acquired by the acquisition processing.

13. The electronic device according to claim 12, wherein
in the control processing, at least one of an amplitude, a cycle, a number of vibration periods, a length of a vibration period, and an interval between a plurality of vibration periods of the vibration is controlled.

14. The electronic device according to claim 12, wherein
in the control processing, the vibration is controlled on a basis of a type of the object.

15. The electronic device according to claim 14, wherein
in a case where the object includes a number, the vibration is controlled on a basis of the number in the control processing.

16. The electronic device according to claim 14, wherein
in a case where the object includes a character, the vibration is controlled on a basis of the character in the control processing.

17. The electronic device according to claim 14, wherein
in a case where the object includes braille, the vibration is controlled on a basis of the braille in the control processing.

18. The electronic device according to claim 12, wherein
in the detection processing, a distance between the object and the indicator is further detected, and
in the control processing, the vibration is controlled further on a basis of the distance.

19. The electronic device according to claim 1, wherein
in the control processing, in a case where the selection of the object by the indicator is not detected by the detection processing, control is performed to give a predetermined notification to the user.

20. The electronic device according to claim 19, wherein
a case where the selection of the object by the indicator has not been detected by the detection processing includes a case where the indicator is not included in the captured image.

21. The electronic device according to claim 1, wherein
in a case where the selection of the object by the indicator is detected by the detection processing, a plurality of pieces of object information related to the object are acquired in the acquisition processing.

22. The electronic device according to claim 21, wherein
the plurality of pieces of object information includes first object information and second object information, and
in the control processing, control is performed such that a first notification based on the first object information is given by outputting sound, and a second notification based on the second object information is given by vibration.

23. The electronic device according to claim 21, wherein
the plurality of pieces of object information includes first object information and second object information, and
in the control processing, control is performed such that a first notification based on the first object information is given by first vibration, and a second notification based on the second object information is given by second vibration.

24. The electronic device according to claim 23, wherein
the first vibration is vibration of a first vibration device, and
the second vibration is vibration of a second vibration device.

25. The electronic device according to claim 21, wherein
a plurality of selecting methods respectively corresponding to the plurality of pieces of object information are determined in advance as a method of selecting the object by the indicator, and
in the control processing, control is performed to give, to the user, the notification based on the object information corresponding to a method of the selection detected by the detection processing among the plurality of pieces of object information.

26. A control method of an electronic device, comprising:
detecting selection of an object by an indicator on a basis of a captured image of a real space including the object and the indicator;
acquiring information regarding the object; and
in a case where the selection of the object by the indicator is detected by the detection processing, performing control so as to give, to a user, a notification based on the information acquired by the acquisition processing.

27. A non-transitory computer readable medium that stores a program, wherein the program causes a computer to execute a control method of an electronic device, the control method comprising:
detecting selection of an object by an indicator on a basis of a captured image of a real space including the object and the indicator;
acquiring information regarding the object; and
in a case where the selection of the object by the indicator is detected by the detection processing, performing control so as to give, to a user, a notification based on the information acquired by the acquisition processing.
